(19) United States
(12) Patent Application Publication
(10) Pub. No.: US 2021/0237587 A1
(43) Pub. Date: Aug. 5, 2021

(54) BOOSTED ELECTRIC PROPULSION SYSTEM FOR ELECTRIC TRUCK AND HIGH PERFORMANCE VEHICLES

(71) Applicant: GM GLOBAL TECHNOLOGY OPERATIONS LLC, Detroit, MI (US)

(72) Inventors: Thomas W. Nehl, Shelby Township, MI (US); Alireza Fatemi, Canton, MI (US); Chandra S. Namuduri, Troy, MI (US)

(73) Assignee: GM GLOBAL TECHNOLOGY OPERATIONS LLC, Detroit, MI (US)

(21) Appl. No.: 16/782,681

(22) Filed: Feb. 5, 2020

(51) Int. Cl. B60L 15/20; H02K 11/33

(52) U.S. Cl. CPC B60L 15/2045; B60L 50/60; H02K 11/33

(57) ABSTRACT

A modular drive system includes a first motor and a second motor. The first motor generates a first torque over a first torque bandwidth, and has a first stator, a first rotor, and a first winding. The first winding has a first number of turns, a first conductor area and a first insulation suitable for a first peak voltage of the first motor. The second motor generates the first torque over a second torque bandwidth, and has a second stator matching the first stator, a second rotor matching the first rotor and a second winding. The second winding has the first number of turns, the first conductor area and a second insulation suitable for a second peak voltage of the second motor. The second peak voltage is greater than the first peak voltage. The second torque bandwidth is wider than the first torque bandwidth.

### INTRODUCTION

The present disclosure relates to a system and a method for a boosted electric propulsion system for electric truck and high performance vehicles.

Electric trucks have wide power demands to accommodate commuting, hauling and trailering. The design criteria of performance electric vehicles includes high acceleration performance and high speed performance demands. Existing electric drive systems have a torque power region up to a base speed. Above the base speed, the electric drive systems have an approximately constant power region. The constant power region means that a single large electric motor, or several smaller electric motors, are implemented to meet specified torque. In practice, three to four of the smaller electric motors are commonly implemented in electric vehicle designs. The size of a single large electric motor, or implementing multiple smaller electric motors, results in a reduced power density, is not efficient, and creates packaging issues. What is desired is a boosted electric propulsion system technique for electric truck and high performance vehicles.

### SUMMARY

A modular drive system is provided herein. The modular drive system includes a first motor and a second motor. The first motor is configured to generate a first torque over a first torque bandwidth, and has a first stator, a first rotor, and a first winding on the first stator. The first winding has a first number of turns, a first conductor area and a first insulation suitable for a first peak voltage of the first motor. The second motor is configured to generate the first torque over a second torque bandwidth, and has a second stator that matches the first stator, a second rotor that matches the first rotor and a second winding on the second stator. The second winding has the first number of turns, the first conductor area and a second insulation suitable for a second peak voltage of the second motor. The second peak voltage of the second motor is greater than the first peak voltage of the first motor. The second torque bandwidth of the second motor is wider than the first torque bandwidth of the first motor.

In one or more embodiments, the modular drive system further includes a first inverter configured to provide a first electrical power to the first motor at the first peak voltage, and has a first housing volume and a capacitor volume; and a second inverter configured to provide a second electrical power to the second motor at the second peak voltage, and has the first housing volume and the capacitor volume.

In one or more embodiments, the modular drive system further includes a first controller coupled to the first inverter and configured to command a field weakening while the first motor is rotating above a first corner speed; and a second controller coupled to the second inverter and configured to command the field weakening while the second motor is rotating above a second corner speed. The second corner speed is faster than the first corner speed.

In one or more embodiments of the modular drive system, the first controller is configured to operate the first motor in a first mode, and the second controller is configured to operate the second motor alternatively in the first mode and in a second mode.

In one or more embodiments of the modular drive system, the first mode reduces a first allowable peak torque while the first motor is rotating faster than the first corner speed, and the second mode reduces a second allowable peak torque while the second motor is rotating faster than the second corner speed.

In one or more embodiments of the modular drive system, the second controller is further configured to operate the second motor in an intermediate mode while the second motor is rotating faster than the first corner speed.

In one or more embodiments of the modular drive system, the second motor is implemented in place of the first motor and the second inverter is implemented in place of the first inverter within a vehicle.

In one or more embodiments of the modular drive system, the first inverter operates at a first pulse width modulation frequency, the second inverter operates at a second pulse width modulation frequency, and the second pulse width modulation frequency is greater than the first pulse width modulation frequency.

In one or more embodiments, the modular drive system further includes a single-speed gear box coupled to the first motor; and a multiple-speed gear box coupled to the second motor.

A method for generating a modular drive system is provided herein. The method includes creating a first motor and creating a second motor. The first motor is configured to generate a first torque over a first torque bandwidth, and has a first stator, a first rotor, and a first winding on the first stator. The first winding has a first number of turns, a first conductor area and a first insulation suitable for a first peak voltage of the first motor. The second motor is configured to generate the first torque over a second torque bandwidth, and has a second stator that matches the first stator, a second rotor that matches the first rotor and a second winding on the second stator. The second winding has the first number of turns, the first conductor area and a second insulation suitable for a second peak voltage of the second motor. The second peak voltage of the second motor is greater than the first peak voltage of the first motor. The second torque bandwidth of the second motor is wider than the first torque bandwidth of the first motor.

In one or more embodiments, the method further includes creating a first inverter and creating a second inverter. The first inverter is configured to provide a first electrical power to the first motor at the first peak voltage, and has a first housing volume and a capacitor volume. The second inverter is configured to provide a second electrical power to the second motor at the second peak voltage, and has the first housing volume and the capacitor volume.

In one or more embodiments, the method further includes creating a first controller coupled to the first inverter and configured to command a field weakening while the first motor is rotating above a first corner speed; and creating a second controller coupled to the second inverter and configured to command the field weakening while the second motor is rotating above a second corner speed. The second corner speed is faster than the first corner speed.

In one or more embodiments of the method, the first controller is configured to operate the first motor in a first mode, and the second controller is configured to operate the second motor alternatively in the first mode and in a second mode.

In one or more embodiments of the method, the first mode reduces a first allowable peak torque while the first motor is rotating faster than the first corner speed, and the second mode reduces a second allowable peak torque while the second motor is rotating faster than the second corner speed.

In one or more embodiments of the method, the second controller is further configured to operate the second motor in an intermediate mode while the second motor is rotating faster than the first corner speed.

In one or more embodiments, the method further includes implementing the second motor in place of the first motor within a vehicle, and implementing the second inverter in place of the first inverter within the vehicle.

A modular drive system is provided herein. The modular drive system includes a first motor and a second motor. The first motor is configured to generate a first torque over a first torque bandwidth, and has a first stator, a first rotor, and a first winding on the first stator. The first winding has a first number of turns, a first conductor area and a first insulation suitable for a first peak current of the first motor. The second motor is configured to generate the first torque over a second torque bandwidth, and has a second stator that matches the first stator, a second rotor that matches the first rotor and a second winding on the second rotor. The second winding has a second number of turns, a second conductor area and the first insulation suitable for a second peak current of the second current-boosted motor. The second peak current of the second motor is greater than the first peak current of the first motor. The second torque bandwidth of the second motor is wider than the first torque bandwidth of the first motor.

In one or more embodiments, the modular drive system further includes a first inverter configured to provide a first electrical power to the first motor at the first peak current, and has a first housing volume and a capacitor volume; and a second inverter configured to provide a second electrical power to the second motor at the second peak current, and has a second housing volume larger than the first housing volume and another capacitor volume larger than the capacitor volume.

In one or more embodiments, the modular drive system further includes a first controller coupled to the first inverter and configured to command a field weakening while the first motor is rotating above a first corner speed; and a second controller coupled to the second inverter and configured to command the field weakening while the second motor is rotating above a second corner speed. The second corner speed is faster than the first corner speed.

In one or more embodiments, the modular drive system further includes a single-speed gear box coupled to the first motor; and a multiple-speed gear box coupled to the second motor.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic diagram of a modular drive system in accordance with an example embodiment.

FIG. 2 is a graph of peak torque as a function of rotational speed in accordance with an example embodiment of the modular drive system.

FIG. 3 is a graph of peak power as a function of rotational speed in accordance with an example embodiment of the modular drive system.

FIG. 4 is a flow diagram of a calibration method in accordance with an exemplary embodiment of the modular drive system.

FIG. 5 is a graph of a resultant operation using a calibration mapping in accordance with an exemplary embodiment of the modular drive system.

FIG. 6 is a flow diagram of a control method in accordance with an exemplary embodiment of the modular drive system.

FIG. 7 is a graph of torque/power as a function of rotational speed in accordance with an example embodiment of the modular drive system.

FIG. 8 is a schematic diagram of a four-motor vehicle and a two-motor vehicle using a 2× voltage boost in accordance with an example embodiment of the modular drive system.

FIG. 9 is a schematic diagram of the four-motor vehicle and a two-motor vehicle using a 2× current boost in accordance with an example embodiment of the modular drive system.

FIG. 10 is a schematic diagram of a three-motor vehicle and the two-motor vehicle using the 2× voltage boost in accordance with an example embodiment of the modular drive system.

### DETAILED DESCRIPTION

Embodiments of the disclosure may provide a modular drive system suitable for implementation in electric trucks and/or high performance vehicles having a wide range of operating regimes. Adjustable corner speeds and torque bandwidths generally permit a single machine to accommodate both mainstream and high performance applications. The embodiments generally provide a modular drive technology/architecture that enables efficient high performance electric propulsion systems using a reduced number of the existing lower power electric machines where a torque band of operation is widened. The modular drive approach may include creating two or more interchangeable types of motors, inverters, gear boxes, batteries, cooling systems and/or controllers. The creating may include designing, fabricating, manufacturing and/or installing the various components within two or more types of vehicles.

In various embodiments, one or more voltage-boosted or current-boosted permanent magnet motors may be created to increase a torque bandwidth and/or a power density within the vehicles. Where combined with a multi-speed gearbox, the boosted motors may meet low speed torque criteria. The voltage boost or current boost may reduce field weakening and so improves high-speed efficiency and performance.

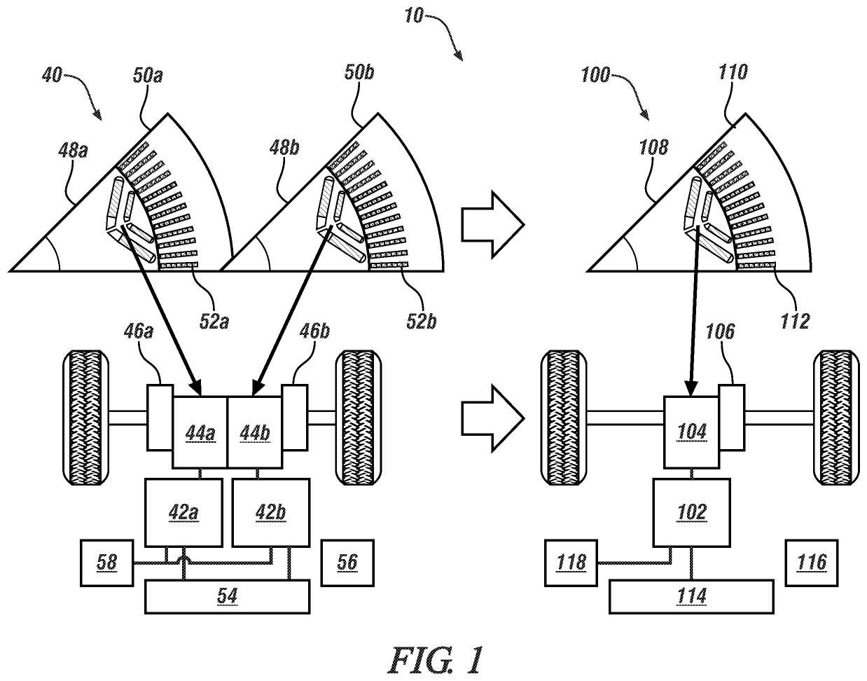

Referring to FIG. 1, a schematic diagram of an example modular drive system 10 is shown in accordance with an example embodiment. The modular drive system 10 generally comprises a first drive system 40 and a second drive system 100. The first drive system 40 may include multiple first inverters 42a-42b, multiple first motors 44a-44b, multiple first gear boxes 46-46b, a first battery 54, a first cooling system 56 and a first controller 58. The first motors 44a-44b may include multiple first rotors 48a-48b, multiple first stators 50a-50b and multiple first windings 52a-52b.

The second drive system 100 generally comprises a second inverter 102, a second motor 104, a second gear box 106, a second battery 114, a second cooling system 116, and a second controller 118. The second motor 104 may include a second rotor 108, a second stator 110, and a second winding 112.

The first drive system 40 and the second drive system 100 may be implemented in a vehicle. The vehicle may be implemented as an electric vehicle. In various embodiments, the electric vehicle may include, but is not limited to, a passenger vehicle, a truck, an autonomous vehicle, a hybrid vehicle, a motorcycle, a boat, a train and/or an aircraft. Other types of electric vehicles may be implemented to meet the design criteria of a particular application.

The first drive system 40 may be referred to as a base drive system. The first drive system 40 is generally operational to provide a variable power, a variable torque and a variable speed to a drive wheel of the vehicle. The first drive system 40 may be configured to generate a normalized one power unit (1PU) of peak power/torque over a normalized one power unit torque bandwidth.

The first inverters 42a-42b may implement multi-phase inverter circuits. The first inverters 42a-42b are generally operational to convert first DC electrical power into first multi-phase electrical power suitable to power the first drive system 40. The first DC electrical power may be in a range of 250 to 400 volts DC (direct current).

The first motors 44a-44b may implement permanent magnet electric motors (or machines). The first motors 44a-44b are generally operational to generate a first power/torque from the first multi-phase electrical power received from the first inverters 42a-42b. In various embodiments, the first motor 44a may be coupled to the first inverter 42a. The second motor 44b may be coupled to the second inverter 42b. Other types of electric motors, such as induction motors, may be implemented to meet the design criteria of a particular application.

The first gear boxes 46-46b may implement single-speed gear boxes. The first gear boxes 46a-46b may be operational to transfer the first power/torque received from the first motors 44a-44b to drive wheels of the first drive system 40. Multiple-speed gear boxes may be implemented to meet the design criteria of a particular application.

The first rotors 48a-48b may implement permanent magnet rotors. The first rotors 48a-48b are generally operational to create the first power/torque from electromagnetic fields generated within the first motors 44a-44b by the first windings 52a-52b.

The first stators 50a-50b may implement electromagnetic stators. The first stators 50a-50b are generally operational to support the first windings 52a-52b surrounding the first rotors 48a-48b. Each first stator 50a-50b generally comprise a series of steel laminates that form a stator stack.

The first windings 52a-52b may implement multiple conductive windings. The first windings 52a-52b are disposed in the first stators 50a-50b. The first winding 52a-52b may be operational to generate the electromagnetic fields used to rotate the first rotors 48a-48b from the first multi-phase electrical power.

The first windings 52a-52b may be coated with a first insulator to provide a first level of electrical insulation among the various windings and the stator stacks. The first level of electrical insulation may be suitable to isolate up to a first peak voltage (e.g., 400 volts DC) present in the first multi-phase electrical power.

The first battery 54 may be operational to provide the first DC electrical power to the first inverters 42a-42b. The first DC electrical power may be in a range of 250 volts DC to 400 volts DC. The first battery 54 generally has a first battery power.

The first cooling system 56 may be operational to provide cooling for the first motors 44a-44b and the first inverters 42a-42b. The first cooling system 56 generally has a first cooling capacity.

The first controller 58 may implement an electric drive control circuit (or device). The first controller 58 is generally operational to control operations of the first motors 44a-44b through control of the first inverters 42a-42b. The first controller 58 may be implemented in hardware and/or software executing on the hardware.

The second drive system 100 may be referred to as a wide torque band (WTB) drive system. The second drive system 100 is generally operational to provide a variable power, a variable torque and a variable speed to a drive wheel of the vehicle. The second drive system 100 may be configured to generate a normalized one peak power/torque of one power unit to several (e.g., two) power units over a normalized wide torque bandwidth of one power units to several (e.g., two) power units.

The second inverter 102 may implement a multi-phase inverter circuit. The second inverter 102 is generally operational to convert second DC electrical power into second multi-phase electrical power suitable to power the second drive system 100. The second DC electrical power may be in a range of 250 volts DC to 1,000 volts DC (e.g., 800 Vdc).

The second motor 104 may implement a permanent magnet electric motor (or machine). The second motor 104 is generally operational to create a second power/torque from the second multi-phase electrical power received from the second inverter 102. In various embodiments, the second motor 104 may be coupled to the second inverter 102. Other types of electric motors, such as induction motors, may be implemented to meet the design criteria of a particular application.

The second motor 104 may have a wider torque bandwidth than the first motors 44a-44b by increasing the voltage and/or current used in the second motor 104 relative to the first motors 44a-44b. In some embodiments, the second motor 104 may be powered by a higher second voltage of the second DC electrical power relative to the first voltage of the first DC electrical power. For example, the second voltage used by the second inverter 102 and the second motor 104 may be a multiple of (e.g., twice) the first voltage used by the first inverters 42a-42b and the first motors 44a-44b.

In other embodiments, the second motor 104 may consume a higher second current of the second DC electrical power relative to a first current of the first DC electrical power. For example, the second current used by the second inverter 102 and the second motor 104 may be a multiple of (e.g., twice) the first current used by the first inverters 42a-42b and the first motors 44a-44b.

The second gear box 106 may implement a multiple-speed (e.g. two-speed) gear box. The second gear box 106 may be operational to transfer the second power/torque received from the second motor 104 to a drive wheel of the second drive system 100. Other multiple-speed gear boxes may be implemented to meet the design criteria of a particular application.

The second rotor 108 may implement a permanent magnet rotor. The second rotor 108 is generally operational to create the second power/torque from electromagnetic fields generated within the second motor 104 by the second windings 112. In various embodiments, a structure of the second rotor 108 may match a structure of the first rotors 48a-48b.

The second stator 110 may implement an electromagnetic stator. The second stator 110 is generally operational to support the second winding 112 surrounding the second rotor 108. The second stator 110 generally comprises the series of steel laminates that form the stator stack. In various embodiments, a structure of the second stator 110 may match a structure of the first stators 50a-50b.

The second winding 112 may implement multiple conductive windings. The second winding 112 is disposed in the second stator 110. The second winding 112 may be operational to generate the electromagnetic fields used to rotate the second rotor 108 from the second multi-phase electrical power.

The second winding 112 may be coated with a second insulator to provide a second level of electrical insulation among the various windings and the stator stack. The second level of electrical insulation may be suitable to isolate up to a second peak voltage (e.g., 1,000 volts DC) present in the second multi-phase electrical power.

The second battery 114 may be operational to provide the second DC electrical power to the second inverter 102. The second DC electrical power may be in a range of 250 volts DC to 1,000 volts DC. The second battery 114 is generally operational to provide a second battery power to the second inverter 102. In various embodiments, the second battery power of the second battery 114 may be greater than the first battery power of the first battery 54

The second cooling system 116 may be operational to provide cooling for the second motor 104 and the second inverter 102. The second cooling system 116 generally has a second cooling capability. In various embodiments, the second cooling capability of the second cooling system 116 may be greater than the first cooling capability of the first cooling system 56.

The second controller 118 may implement an electric drive control circuit (or device). The second controller 118 is generally operational to control operations of the second motor 104 through control of the second inverter 102. The second controller 118 may be implemented in hardware and/or software executing on the hardware.

In various embodiments, the modular drive system 10 may be implemented with the second motor 104 utilizing twice the voltage or twice the current as the first motors 44a-44b. The double voltage or double current may be referred to as a “2×” boost. If the voltage-based WTB technique is implemented, there are no changes between the first motors 44a-44b and the second motor 104 except for the insulation rating. If the current-based WTB technique is implemented, the second winding 112 may be rewound for half the turns relative to the first windings 52a-52b.

Doubling the electrical power consumed by the second motor 104 generally results in doubling the power rating of the second inverter 102 relative to the individual first inverters 42a-42b. For the voltage-based WTB, the second inverter 102 may be implemented with a 2× voltage rating and a same (1×) current rating as each of the first inverters 42a-42b. For the current-based WTB, the second inverter 102 may be implemented with a 2× current rating and a same (1×) voltage rating as each of the first inverters 42a-42b.

To implement the 2× boost, the hardware of the second inverter 102 may be altered relative to the first inverters 42a-42b. For the voltage-based WTB technique, the second inverter may be implemented with a double (2×), voltage rating and a same (1×) current rating. The higher voltage rating may be achieved by replacing silicon (Si) based power transistors used in the first inverters 42a-42b with silicon carbide (SiC) based power transistors. The silicon carbide power transistors generally result in a smaller second inverter 102, whereas the relatively larger die area of the silicon transistors are implemented to compensate for higher “on” resistances. The second inverter 102 may also double a pulse width modulation frequency relative to the first inverters 42a-42b to accommodate fixed-size internal capacitors. Designs of the second inverter 102 may not involve changes in component current ratings relative to the first inverters 42a-42b. Other components in the first inverters 42a-42b and the second inverter 102 may have the same current ratings.

For the current-based WTB technique, the second inverter 102 may have a double (2×) current rating and a same (1×) voltage rating as each of the first inverters 42a-42b. The die area of the (Si) power transistors in the second inverter 102 may be double that of the first inverters 42a-42b. The second inverter 102 may be implemented with double conductor cross-sections to accommodate the higher currents than the first inverters 42a-42b. The second inverter 102 may also have double the capacitor rating as the individual first inverters 42a-42b.

The first controller 58 may be programmed with a single calibration table suitable for a baseline (e.g., a first mode) operation. The second controller 118 may be programmed with multiple (e.g., the first mode, an optional intermediate node and a second mode) calibration tables for the wide torque band operations. Use of the multiple calibration tables may be automatic and/or user (e.g., vehicle driver) selectable.

A configuration of the first battery 54 may comprise Mₛₑᵣᵢₑₛ by Nₚₐᵣₐₗₗₑₗ battery cells. The second battery 114 may be capable of supplying the proper voltage and/or current to the second inverter 102 and the second motor 104. For the voltage-based WTB technique, the second battery 114 may be reconfigured as 2Mₛₑᵣᵢₑₛ by (O±(N/2))ₚₐᵣₐₗₗₑₗ battery cells. The variable N may be an even integer. The variable O may be a number of additional parallel strings (if any) of battery cells appropriate to achieve the 1× current rating. For the current-based WTB technique, the second battery 114 may be configured as M_{series by} (N+P)ₚₐᵣₐₗₗₑₗ battery cells. The variable P may be a number of additional parallel strings (if any) appropriate to achieve the 2× current rating. In general, the voltage-based WTB or the current-based WTB boost may also be supplied by a reconfigurable battery, a buck-boost converter and/or other suitable source of electric power.

While the description above is for a 2× boost case, other boost cases may be implemented in a similar fashion. In general, for boosts of BX, where B is the boost factor:

Peak Power_{WTB}=B*Peak Power_{base} and Peak Torque_{WTB}=Peak Torque_{base};

Voltage-Based Boost: V_{WTB}=B*V_{base} and I_{WTB}=I_{base};

Current-Based Boost: I_{WTB}=B*I_{base} and V_{WTB}=V_{base}; and

Torque band_{WTB}=B*Torque band_{base}.

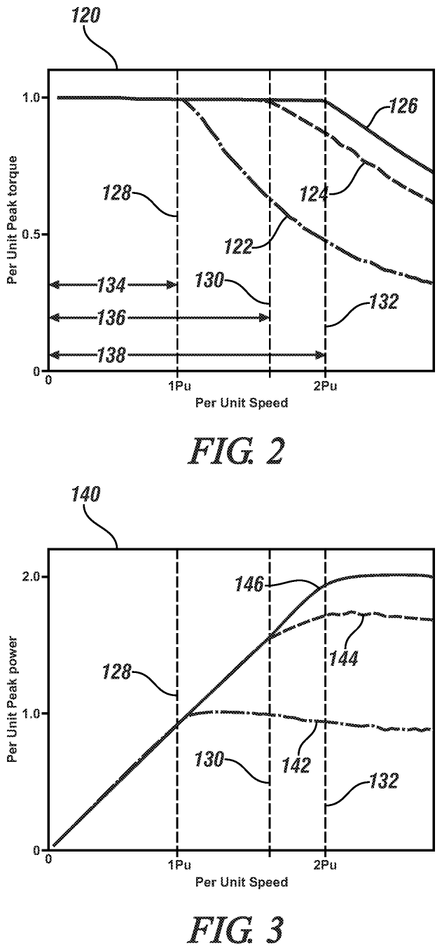

Referring to FIG. 2, a graph 120 of an example peak torque as a function of rotational speed is shown in accordance with an example embodiment of the modular drive system 10. The x-axis may show a rotation speed in terms of power units. The y-axis may show a peak torque in terms of power units.

Curve 122 generally illustrates a first torque profile of a first motor (e.g., 44a). A curve 124 may show an intermediate torque profile of the second motor 104 utilizing an intermediate boost. Curve 126 generally shows a second torque profile of the second motor 104 utilizing a 2× boost.

A first corner speed 128 may occur where the first motor 44a is operated with no boost and is driven into a field weakening operation. A first allowable peak torque in the first torque profile 122 of the first motor 44a may decline at rotational speeds above the first corner speed 128 due to the field weakening. The first corner speed 128 generally defines a first torque bandwidth 134 of the first motors 44a-44b.

An intermediate corner speed 130 may occur where the second motor 104 is operating with an intermediate boost and is driven into the field weakening operation. An intermediate allowable peak torque in the intermediate torque profile 124 of the second motor 104 may decline at rotational speeds above the intermediate corner speed 130 due to the field weakening. The intermediate corner speed 130 generally defines an intermediate torque bandwidth 136 of the second motor 104.

A second corner speed 132 may occur where the second motor 104 is operated at the double boost and is driven into the field weakening operation. A second allowable peak torque in the second torque profile 126 of the second motor 104 may decline at rotational speeds above the second corner speed 132 due to the field weakening. The second corner speed 132 generally defines a second torque bandwidth 138 of the second motor 104.

Referring to FIG. 3, a graph 140 of an example peak power as a function of rotational speed is shown in accordance with an example embodiment of the modular drive system 10. The x-axis may show the rotation speed in terms of power units. The y-axis may show a peak power in terms of power units.

Curve 142 generally illustrates a first power profile of a first motor (e.g., 44a). A curve 144 may show an intermediate power profile of the second motor 104 utilizing an intermediate boost. Curve 146 generally shows a second power profile of the second motor 104 utilizing a 2× boost.

A power of a first motor (e.g., 44a) and the second motor 104 may increase approximately linearly as the rotational speed increases from zero to the first corner speed 128. Above the first corner speed, the power of the first motor 44a operating unboosted may become approximately constant, as shown in the first power profile 142. Above the intermediate corner speed 130, the power of the second motor 104 operating with the intermediate boost may become approximately constant, as shown by the intermediate power profile 144. The second power profile 146 may shown that the second motor 104 operating with the 2× boost may become approximately constant at rotational speeds above the second corner speed 132.

Normalized characteristics of the modular drive system 10 utilizing the 2× voltage-based operation is generally described by Table I as follows:

TABLE I

| | First Drive | Second Drive |
|---|---|---|
| | System 40 | System 100 |
| Performance | 1PU peak power. | 1-2PU peak power. |
| | 1PU peak torque. | 1PU peak torque. |
| | 1PU torque bandwidth. | 1-2OU torque bandwidth. |
| Motor | Baseline rotor/stator. | Baseline rotor/stator. |
| | 1PU turns. | Same winding (turns and |
| | 1PU conductor area. | conductor area). |
| | 1PU voltage insulation. | Increase to 2PU voltage |
| | | insulation for modularity. |
| Inverter | Baseline housing volume. | Baseline housing. |
| | Si power transistors at | Replace with SiC power |
| | 1PU V & I. | transistors (1PU I, 2PU V). |
| | 1PU capacitor volume. | 1PU capacitor volume |
| | | 2X PWM frequency for same |
| | | percentage ripple. |
| Calibration/Control | Calibration for normal | Calibration for both normal |
| | operation. | operation and WTB operation. |
| System | Field weakening control. | Non- field weakening: first |
| | | mode control for improved |
| | | efficiency. |
| | | WTB: second mode control |
| | | for maximum power boost. |
| | | Provide control between |
| | | first mode and second mode. |

Normalized characteristics of the modular drive system 10 utilizing the 2× current-based operation is generally describe by in Table II as follows:

TABLE II

| | First Drive | Second Drive |
|---|---|---|
| | System 40 | System 100 |
| Performance | 1PU peak power. | 1-2PU peak power. |
| | 1PU peak torque. | 1PU peak torque. |
| | 1PU torque bandwidth. | 1-2OU torque bandwidth. |
| Motor | Baseline rotor/stator. | Baseline rotor/stator. |
| | 1PU turns. | Reduce turns to 1/2PU. |
| | 1PU conductor area. | Double conductor area. |
| | 1PU voltage insulation. | 1PU voltage insulation. |
| Inverter | Baseline housing | Double baseline housing. |
| | volume. | Double current rating of |
| | Si power transistors | Si power transistors. |
| | at 1PU V & I. | Double capacitor volume |
| | 1PU capacitor volume. | (2PU) for same |
| | | percentage ripple. |
| Calibration/Control | Calibration for normal | Calibration for both |
| | operation. | normal operation and |
| | | WTB operation. |
| System | Field weakening control. | Non- field weakening: |
| | | first mode control for |
| | | improved efficiency. |
| | | WTB: second mode control |
| | | for maximum power boost. |
| | | Provide control between |
| | | first mode and second |
| | | mode. |

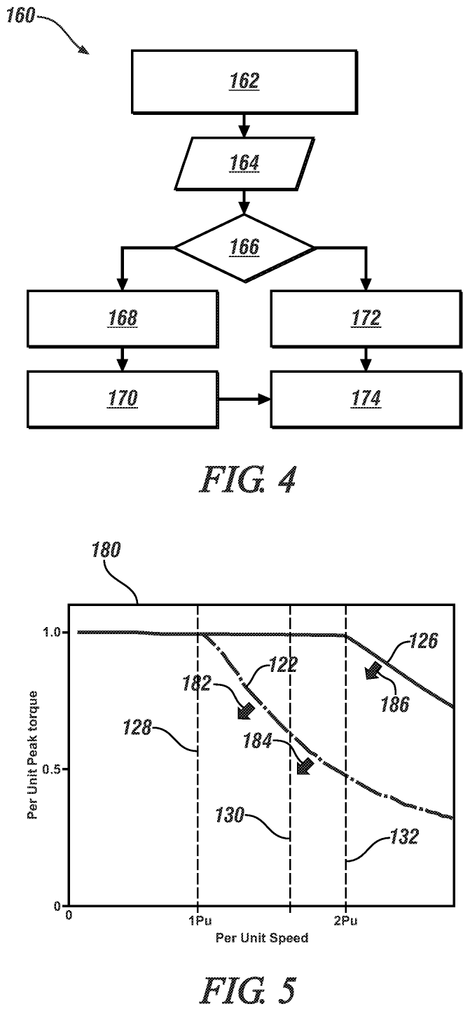

Referring to FIG. 4, a flow diagram of an example calibration method 160 is shown in accordance with an exemplary embodiment of the modular drive system 10. The calibration method (or process) 160 may be implemented with the modular drive system 10. The calibration method 160 generally comprises a step 162, a step 164, a decision step 166, a step 168, a step 170, a step 172 and a step 174. The sequence of steps is shown as a representative example. Other step orders may be implemented to meet the criteria of a particular application.

In the step 162, d-axis and q-axis flux lookup tables may be generated. The flux lookup table may be incorporated in an e-drive specification in the step 164. The decision step 166 may determine if the calibration is for the baseline operation or the wide torque bandwidth operation. For baseline operation, the step 168 may generate a first calibration map (e.g., Map 1) for maximum torque per ampere (MTPA)/maximum torque per volt (MTPV)/maximum torque per loss (MTPL) operation for either a 1PU voltage operation or a 1PU current operation. A peak torque (Tp) versus speed curve may be extracted from the first calibration map 1 in the step 170. In the step 174, an efficiency calibration map (e.g., Map 2.1) contour and/or a performance calibration map (e.g., Map 2.2) contour may be specified from the first calibration map.

For the performance operation, the step 172 may generate a second calibration map (e.g., Map 2) for the maximum torque per ampere/maximum torque per volt operation for either a 2PU voltage operation or a 2PU current operation. The efficiency calibration map (e.g., Map 2.1) contour and/or a performance calibration map (e.g., Map 2.2) contour may be specified from the performance calibration map in the step 174. The baseline calibration map may be stored in the first controller 58. The baseline calibration map, the efficiency calibration map and the performance calibration map may be stored in the second controller 118.

Referring to FIG. 5, a graph 180 of an example resultant operation using a given calibration mapping is shown in accordance with an exemplary embodiment of the modular drive system 10. The x-axis may show the rotation speed in terms of power units. The y-axis may show the peak torque in terms of power units.

A performance of the first motors 44a-44b and the second motor 104 may be controlled based on the rotational speed requested by the user and the torque/power load placed on the motors. The first controller 58 may be calibrated to govern the speeds and torques of the first motors 44a-44b to stay within the first torque profile 122, as indicated by a first mode 182. The first mode 182 may be referred to as a base mode and may utilize the first calibration Map 1. The second controller 118 may be calibrated to govern the speed and the torque of the second motor 104 in an intermediate mode 184 and a second mode 186. The intermediate mode 184 may operate the second motor 104 within the first torque profile 122. The intermediate mode 184 may be referred to as an efficiency mode that utilizes the efficiency calibration Map 2.1 and does not implement field weakening. The second mode 186 may operate the second motor 104 within the second torque profile 126. The second mode 186 may be referred to as a performance mode that utilizes the performance calibration Map 2.2 and may implement field weakening above the second corner speed 132. In various situations, the second motor 104 may be controlled by the second torque profile 126 even though the second motor 104 is at a low speed and/or low torque within the first torque profile 122 (e.g., a speed of 0.5 PU or a peak torque of 0.25 PU).

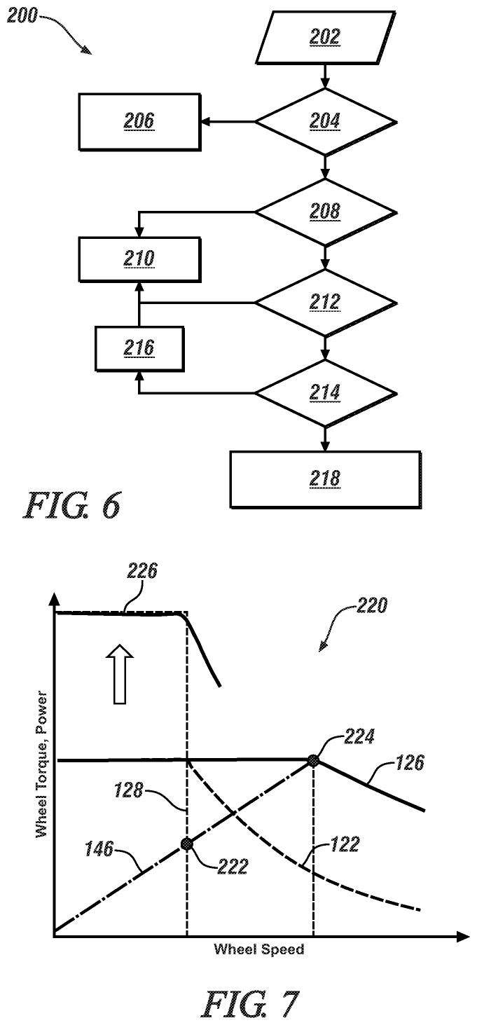

Referring to FIG. 6, a flow diagram of an example control method 200 is shown in accordance with an exemplary embodiment of the modular drive system 10. The control method (or process) 200 may be implemented in the first controller 58 and the second controller 118. The control method 200 generally comprises a step 202, a decision step 204, a step 206, a decision step 208, a step 210, a decision step 212, a decision step 214, a step 216 and a step 218. The sequence of steps is shown as a representative example. Other step orders may be implemented to meet the criteria of a particular application.

In the step 202, the torque (T), the rotational speed (w) and a configuration mode may be determined for current operations of the first drive system 40 and the second drive system 100. If the configuration mode is a baseline torque band mode (e.g., the first motors 44a-44b or the second motor 104 is implemented) per the decision step 204, the first controller 58 and/or the second controller 118 may utilize the baseline calibration Map 1 in the step 206.

If the configuration mode is the wide torque band mode (e.g., the second motor 104 is implemented) per the decision step 204, the rotational speed w of the second motor 104 may be checked in the decision step 208. If the rotational speed w of the second motor 104 is less that the first corner speed 128 (ω_{b}) per the decision step 208, the second controller 118 may utilize the efficiency calibration map 2.1 in the step 210.

If the rotational speed w of the second motor 104 is greater that the first corner speed 128 ω_{b}, the torque load on the second motor 104 may be compared to the peak torque Tp in the decision step 212. If the torque load is less than the peak torque Tp, the second controller 118 may utilize the efficiency calibration Map 2.1 in the step 210. If the torque load is greater than the peak torque Tp, the second controller 118 may determine if the second motor 104 should be operated in the intermediate (or efficiency) mode 184 or the second (or performance) mode 186 in the decision step 214. Selection between the intermediate/efficiency mode 184 and the second/performance mode 186 may be user (e.g., driver) selectable and/or automatically selected by the second controller 118.

While the intermediate/efficiency mode is selected per the decision step 214, the torque may be set to the peak torque Tp in the step 216 and the second controller 118 may utilize the efficiency calibration Map 2.1 in the step 210. While the second/performance mode is selected per the decision step 214, the second controller 118 may utilize the performance calibration Map 2.2 in the step 218.

Referring to FIG. 7, a graph 220 of an example torque/power as a function of rotational speed is shown in accordance with an example embodiment of the modular drive system 10. The x-axis may show the rotation speed. The y-axis may show the torque/power.

Various embodiments generally enable the replacement of multiple (e.g., two) first motors 44a-44b with a single second motor 104. The single second motor 104 may implement a voltage boosted motor or a current boosted motor. Two first drive systems 40 may be implemented to achieve a specified power and low speed torque, as indicated by the power profile 146. At a point 222, the peak torque produced by the two first drive systems 40 may be reduced per the first torque profile 122.

A single second drive system 100 generally provides the same power, but not the low speed torque of the two first drive systems 40. The second drive system 100 may also achieve the specified power and low speed torque, as indicated by the power profile 146. At a point 224, the peak torque produced by the second drive system 1000 may be reduced per the second torque profile 126.

To achieve a higher low speed torque, the second drive system 100 may include a multiple-speed (e.g., two-speed) gear box or differential. The multiple-speed gear box generally increases the low speed torque up to a higher torque profile 226. Other boost ratios besides 2× may be implemented to achieve the design criteria of a particular application.

Replacing multiple first drive systems 40 with a single second drive system 100 generally cuts core losses (e.g., cuts in half). The implementation of fewer second inverters 102 and fewer second motors 104 may reduce housing size and weight, resulting in improved packaging and reduced mass. Use of the multiple-speed differential or gearbox may also boost low speed torque.

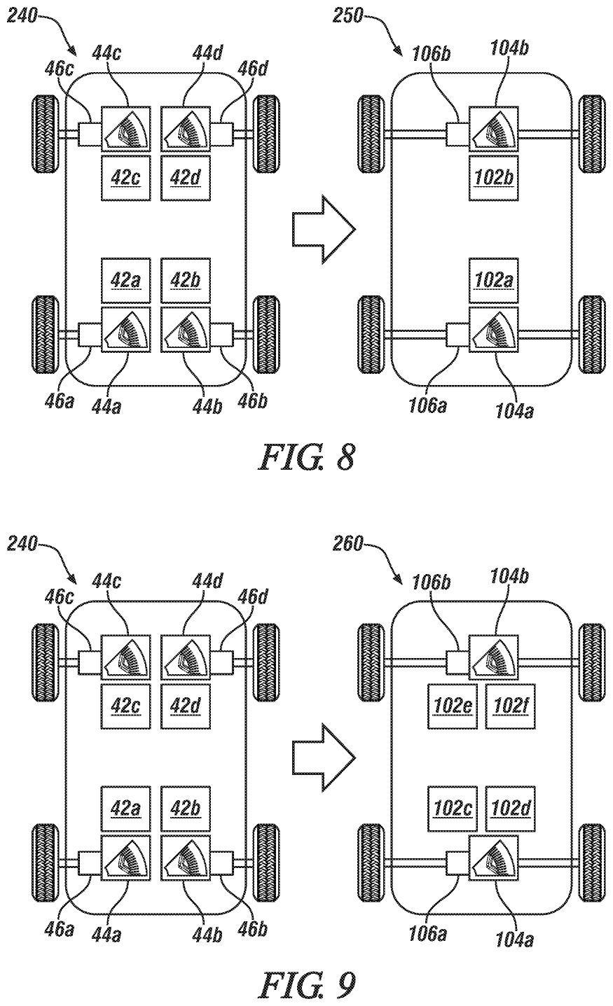

Referring to FIG. 8, a schematic diagram of an example four-motor vehicle 240 and an example two-motor vehicle 250 using a 2× voltage boost is shown in accordance with an example embodiment of the modular drive system 10. The four-motor vehicle 240 may be implemented using four sets of the first drive system 40 to achieve a 4PU capability. The two-motor vehicle 250 may be implemented with two sets of the second drive system 100 to achieve the same 4PU capability.

The four sets of the first drive systems 40 generally comprise four inverters 42a-42d, four first motors 44a-44d and four first gear boxes 46a-46d. The two sets of the second drive system 100 generally comprise two second inverters 102a-102b, two second motors 104a-404b (configured for the 2× voltage boost) and two second gear boxes 106a-106b.

The motors in both the four-motor vehicle 240 and the two-motor vehicle 250 may be based on the same stator, rotor and winding designs. The vehicles 240 and 250 may have the same fixed electromagnetic designs. The two-motor vehicle 250 may benefit from the wide torque bandwidth operation based on the voltage boost, half the total inverter packaging volume and mass, half the total motor volume and mass, and reduced spin losses relative to the four-motor vehicle 240.

Referring to FIG. 9, a schematic diagram of the four-motor vehicle 240 and an example two-motor vehicle 260 using a 2× current boost is shown in accordance with an example embodiment of the modular drive system 10. The four-motor vehicle 240 may be implemented using four sets of the first drive system 40 to achieve a 4PU capability. The two-motor vehicle 260 may be implemented with two sets of the second drive system 100 to achieve the same 4PU capability.

The four sets of the first drive systems 40 generally comprise four inverters 42a-42d, four first motors 44a-44d and four first gear boxes 46a-46d. The two sets of the second drive system 100 generally comprise two (double-wide) second inverters 102c-102f, two second motors 104a-404b (configured for the 2× current boost) and two second gear boxes 106a-106b.

The motors in both the four-motor vehicle 240 and the two-motor vehicle 260 may be based on the same stator and rotor designs. The vehicles 240 and 260 may have the same fixed electromagnetic designs. The two-motor vehicle 260 may benefit from the wide torque bandwidth operation based on the current boost, have the same total inverter packaging volume and mass, half the total motor volume and mass, and reduced spin losses relative to the four-motor vehicle 240.

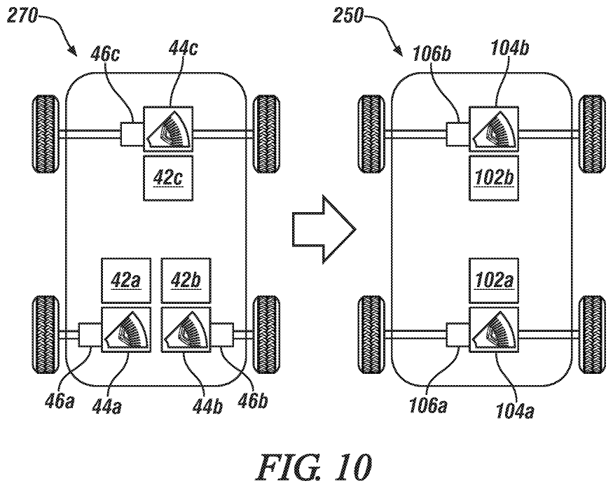

Referring to FIG. 10, a schematic diagram of an example three-motor vehicle 270 and the two-motor vehicle 250 using the 2× voltage boost is shown in accordance with an example embodiment of the modular drive system 10. The three-motor vehicle 270 may be implemented using three sets of the first drive system 40 to achieve a 3PU capability. The two-motor vehicle 250 may be implemented with two sets of the second drive system 100 to achieve the 4PU capability.

The three sets of the first drive systems 40 generally comprise three inverters 42a-42c, three first motors 44a-44c and three first gear boxes 46a-46dc. The two sets of the second drive system 100 generally comprise two second inverters 102a-102b, two second motors 104a-404b (configured for the 2× voltage boost) and two second gear boxes 106a-106b.

The motors in both the three-motor vehicle 270 and the two-motor vehicle 250 may be based on the same stator, rotor and winding designs. The two vehicles 270 and 250 may have the same fixed electromagnetic designs. The two-motor vehicle 250 may benefit from the wide torque bandwidth operation based on the voltage boost, two-thirds the total inverter packaging volume and mass, two-thirds the total motor volume and mass, reduced spin losses, and provide a higher power capacity relative to the three-motor vehicle 270

Embodiments of the disclosure generally provide a modular technique that uses the same motor components for both baseline and high performance applications. High performance may be achieved with the wide torque band (voltage boost or current boost) operations. The modular drive system approach generally allows for a fixed electromagnetic design and increased utilization of rare earth magnets. A single wide torque bandwidth machine with a two-speed gear box may provide performance similar to that of two baseline machines. The wide torque bandwidth technique may provide a power density increase, improved high speed performance and improved efficiency while simultaneously decreasing the number and packaging volume/mass of the drives.

The modular drive system generally provides a modular permanent magnet electric propulsion system, and other motor types (e.g., induction, synchronous reluctance, etc.), where the motor voltage or current is increased to raise the base speed (torque band). The modular design may include maintaining a fixed peak ampere-turns of the machine windings, maintaining a fixed design of the stator and the rotor cores, magnets and other components. Therefore, a given electric machine may accommodate both baseline (mainstream) and high performance applications.

The second drive systems may replace two machines on a single axle with one wide torque bandwidth machine. For a 2× voltage or a 2× current based design, the boosting may double the power with same peak torque. If additional torque is specified, the boosted machine may use a higher ratio gear box, a multispeed transmission, or a selectable differential. Other numbers of machine/axle configurations may be implemented. In various embodiments, boost ratios other than 2× may be implemented to meet the design criteria of a particular application.

While the best modes for carrying out the disclosure have been described in detail, those familiar with the art to which this disclosure relates will recognize various alternative designs and embodiments for practicing the disclosure within the scope of the appended claims.

What is claimed is:

1. A modular drive system comprising:
a first motor configured to generate a first torque over a first torque bandwidth, and has a first stator, a first rotor, and a first winding on the first stator, wherein the first winding has a first number of turns, a first conductor area and a first insulation suitable for a first peak voltage of the first motor; and
a second motor configured to generate the first torque over a second torque bandwidth, and has a second stator that matches the first stator, a second rotor that matches the first rotor and a second winding on the second stator, wherein the second winding has the first number of turns, the first conductor area and a second insulation suitable for a second peak voltage of the second motor,
wherein the second peak voltage of the second motor is greater than the first peak voltage of the first motor, and the second torque bandwidth of the second motor is wider than the first torque bandwidth of the first motor.

2. The modular drive system according to claim 1, further comprising:
a first inverter configured to provide a first electrical power to the first motor at the first peak voltage, and has a first housing volume and a capacitor volume; and
a second inverter configured to provide a second electrical power to the second motor at the second peak voltage, and has the first housing volume and the capacitor volume.

3. The modular drive system according to claim 2, further comprising:
a first controller coupled to the first inverter and configured to command a field weakening while the first motor is rotating above a first corner speed; and
a second controller coupled to the second inverter and configured to command the field weakening while the second motor is rotating above a second corner speed,
wherein the second corner speed is faster than the first corner speed.

4. The modular drive system according to claim 3, wherein the first controller is configured to operate the first motor in a first mode, and the second controller is configured to operate the second motor alternatively in the first mode and in a second mode.

5. The modular drive system according to claim 4, wherein the first mode reduces a first allowable peak torque while the first motor is rotating faster than the first corner speed, and the second mode reduces a second allowable peak torque while the second motor is rotating faster than the second corner speed.

6. The modular drive system according to claim 5, wherein the second controller is further configured to operate the second motor in an intermediate mode while the second motor is rotating faster than the first corner speed.

7. The modular drive system according to claim 2, wherein the second motor is implemented in place of the first motor and the second inverter is implemented in place of the first inverter within a vehicle.

8. The modular drive system according to claim 2, wherein the first inverter operates at a first pulse width modulation frequency, the second inverter operates at a second pulse width modulation frequency, and the second pulse width modulation frequency is greater than the first pulse width modulation frequency.

9. The modular drive system according to claim 1, further comprising:
a single-speed gear box coupled to the first motor; and
a multiple-speed gear box coupled to the second motor.

10. A method for generating a modular drive system comprising:
creating a first motor configured to generate a first torque over a first torque bandwidth, and has a first stator, a first rotor, and a first winding on the first stator, wherein the first winding has a first number of turns, a first conductor area and a first insulation suitable for a first peak voltage of the first motor; and
creating a second motor configured to generate the first torque over a second torque bandwidth, and has a second stator that matches the first stator, a second rotor that matches the first rotor and a second winding on the second stator, wherein the second winding has the first number of turns, the first conductor area and a second insulation suitable for a second peak voltage of the second motor,
wherein the second peak voltage of the second motor is greater than the first peak voltage of the first motor, and the second torque bandwidth of the second motor is wider than the first torque bandwidth of the first motor.

11. The method according to claim 10, further comprising:
creating a first inverter configured to provide a first electrical power to the first motor at the first peak voltage, and has a first housing volume and a capacitor volume; and
creating a second inverter configured to provide a second electrical power to the second motor at the second peak voltage, and has the first housing volume and the capacitor volume.

12. The method according to claim 11, further comprising:
creating a first controller coupled to the first inverter and configured to command a field weakening while the first motor is rotating above a first corner speed; and
creating a second controller coupled to the second inverter and configured to command the field weakening while the second motor is rotating above a second corner speed,
wherein the second corner speed is faster than the first corner speed.

13. The method according to claim 12, wherein the first controller is configured to operate the first motor in a first mode, and the second controller is configured to operate the second motor alternatively in the first mode and in a second mode.

14. The method according to claim 13, wherein the first mode reduces a first allowable peak torque while the first motor is rotating faster than the first corner speed, and the second mode reduces a second allowable peak torque while the second motor is rotating faster than the second corner speed.

15. The method according to claim 14, wherein the second controller is further configured to operate the second motor in an intermediate mode while the second motor is rotating faster than the first corner speed.

16. The method according to claim 11, further comprising:
implementing the second motor in place of the first motor within a vehicle; and
implementing the second inverter in place of the first inverter within the vehicle.

17. A modular drive system comprising:
a first motor configured to generate a first torque over a first torque bandwidth, and has a first stator, a first rotor, and a first winding on the first stator, wherein the first winding has a first number of turns, a first conductor area and a first insulation suitable for a first peak current of the first motor; and
a second motor configured to generate the first torque over a second torque bandwidth, and has a second stator that matches the first stator, a second rotor that matches the first rotor and a second winding on the second rotor, wherein the second winding has a second number of turns, a second conductor area and the first insulation suitable for a second peak current of the second motor,
wherein the second peak current of the second motor is greater than the first peak current of the first motor, and the second torque bandwidth of the second motor is wider than the first torque bandwidth of the first motor.

18. The modular drive system according to claim 17, further comprising:
a first inverter configured to provide a first electrical power to the first motor at the first peak current, and has a first housing volume and a capacitor volume; and
a second inverter configured to provide a second electrical power to the second motor at the second peak current, and has a second housing volume larger than the first housing volume and another capacitor volume larger than the capacitor volume.

19. The modular drive system according to claim 18, further comprising:
a first controller coupled to the first inverter and configured to command a field weakening while the first motor is rotating above a first corner speed; and
a second controller coupled to the second inverter and configured to command the field weakening while the second motor is rotating above a second corner speed,
wherein the second corner speed is faster than the first corner speed.

20. The modular drive system according to claim 17, further comprising:
a single-speed gear box coupled to the first motor; and
a multiple-speed gear box coupled to the second motor.
